(19) United States
(12) Patent Application Publication
(10) Pub. No.: US 2017/0003002 A1
(43) Pub. Date: Jan. 5, 2017

(54) LENS AND LED LIGHTING APPARATUS HAVING THE SAME

(71) Applicant: Posco LED Company Ltd., Yongin-si (KR)

(72) Inventors: Su Woon LEE, Yongin-si (KR); Sang Hyuk Kim, Yongin-si (KR); Yoon Gil Jang, Yongin-si (KR); Seok Jin Kang, Yongin-si (KR)

(21) Appl. No.: 14/790,402

(22) Filed: Jul. 2, 2015

(51) Int. Cl. F21V 13/04; F21V 5/00; F21V 7/00; F21K 99/00

(52) U.S. Cl. CPC F21V 13/04; F21K 9/54; F21V 5/007; F21V 7/0083; F21Y 2105/001

(57) ABSTRACT

A lens may include: a lens part including an incidence surface onto which light is incident and a emission surface through which the light incident onto the incidence surface is emitted, and an outer surface which reflects the light incident onto the incidence surface toward the emission surface; and a holder part including a lens housing integrally connected with edge of the emission surface and surrounds an outer peripheral of the lens part, and at least one alignment protrusion located at a lower portion of the lens housing.

### BACKGROUND

Field

Exemplary embodiments relate to a lens. More particularly, exemplary embodiments relate to a lens for a light emitting diode (LED) lighting apparatus.

Discussion of the Background

An LED is a semiconductor element that may be made of a material, such as gallium (Ga), phosphorus (P), arsenic (As), indium (In), nitrogen (N), aluminum (Al), etc. The LED may emit any suitable color, such as red, green, blue, etc., light when a current is applied. As compared with a fluorescent lamp, the LED may have a relatively longer lifespan, a relatively faster response speed when excited (e.g. time until light is emitted after a current flows), and a relatively lower power consumption. Due, at least in part, to these advantages, the use of LEDs is increasing. Accordingly, LEDs have found use in various kinds of lighting apparatus, such as bulbs, tubes, recessed lights, and street lamps, etc.

In general, the LED may be fabricated as a package and bonded on a Printed Circuit Board (PCB). The LED package may include an LED chip, a chip plate accommodating the LED chip, and an optical member located on the LED chip.

Also, after the LED package is bonded on the PCB, a lens may be further included in order to enhance a beam angle and/or uniformity of the light emitted from the LED package.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a lens combined with an LED package. The lens includes a lens part and a lens housing which surrounds an outer peripheral edge of the lens part, wherein the lens housing is integrally formed within one body with the lens part.

Further, the lens housing comprises at least one alignment protrusion at the lower portion of the lens housing, and the alignment protrusion is inserted to an alignment groove formed on a PCB of an LED lighting apparatus to combine with the LED package and the PCB.

Additional aspects will be set forth in the detailed description which follows, and, in part, will be apparent from the disclosure, or may be learned by practice of the inventive concept.

According to an exemplary embodiment, a lens may include: a lens part including an incidence surface onto which light is incident and a emission surface through which the light incident onto the incidence surface is emitted, and an outer surface which reflects the light incident onto the incidence surface toward the emission surface; and a holder part including a lens housing integrally connected with an edge of the emission surface and surrounding an outer peripheral of the lens part, and at least one alignment protrusion located at a lower portion of the lens housing.

The incidence surface may be formed along a recess that extends toward the emission surface.

The incidence surface may include a refractive surface comprising a bottom of the recess and an inner surface extending away from the refractive surface to form a side of the recess.

An optical member of an LED package may be inserted to the inside of the lens part through an opening area of the recess.

A width of an opening area of the recess may be formed larger than that of an optical member of an LED package.

The lens part may further include a lower surface, and the lower surface may enclose an opening area of the recess and contact an upper side of a chip plate of an LED package.

The emission surface may comprise a first surface corresponding to lighting side, and a second surface extending from the outer edge of the first surface and may be connected integrally to the lens housing of the holder part.

The height of the lens housing may be greater than a height of the outer surface of the lens part.

According to another exemplary embodiment, an LED lighting apparatus may include: a printed circuit board PCB on which a plurality of LED packages is arranged; a plurality of alignment grooves formed on the PCB corresponding to a plurality of the LED packages; and a plurality of lenses inserted or wedged into the plurality of alignment grooves corresponding to a plurality of the LED packages; wherein each of the lenses comprises; a lens part including an incidence surface onto which light is incident, an emission surface through which the light incident onto the incidence surface is emitted, and an outer surface which reflects the light incident onto the incidence surface toward the emission surface; and a holder part including a lens housing integrally connected with an edge of the emission surface and surrounding an outer peripheral of the lens part, and a plurality of alignment protrusions located at a lower portion of the lens housing and inserted or wedged into the plurality of alignment grooves.

According to another exemplary embodiment, a lens may include: a lens part including an incidence surface onto which light is incident, an emission surface through which the light incident onto the incidence surface is emitted, and an outer surface which reflects the light incident onto the incidence surface toward the emission surface; and a lens housing integrally connected with an edge of the emission surface and surrounding an outer peripheral of the lens part, wherein the incidence surface is formed along a recess that extends toward the emission surface, and wherein only an optical member of an LED package is inserted into the inside of the lens part through an opening area of the recess.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1A is an exploded perspective view of a lens according to an exemplary embodiment.

FIG. 1B is an assembled view of the lens in FIG. 1A having an LED package coupled thereto.

FIG. 1C is a cross sectional view of the central region of the lens in FIG. 1B.

FIG. 2 is an assembled view showing a problem of the lens in FIG. 1A through FIG. 1C.

FIG. 3A is an exploded perspective view of a lens according to another exemplary embodiment.

FIG. 3B is an assembled view of the lens in FIG. 3A having an LED package coupled thereto.

FIG. 3C is a cross sectional view of the central region of the lens in FIG. 3B.

FIG. 4 is a view illustrating LED packages in various sizes.

FIG. 5 is a view illustrating a PCB having a plurality of LED packages bonded thereon.

FIG. 6 is an enlarged cross section view illustrating a status of combining with the lens assembly and an alignment groove in the PCB in FIG. 5.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not necessarily intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments of the present invention will be described in detail with reference to the accompanying drawings.

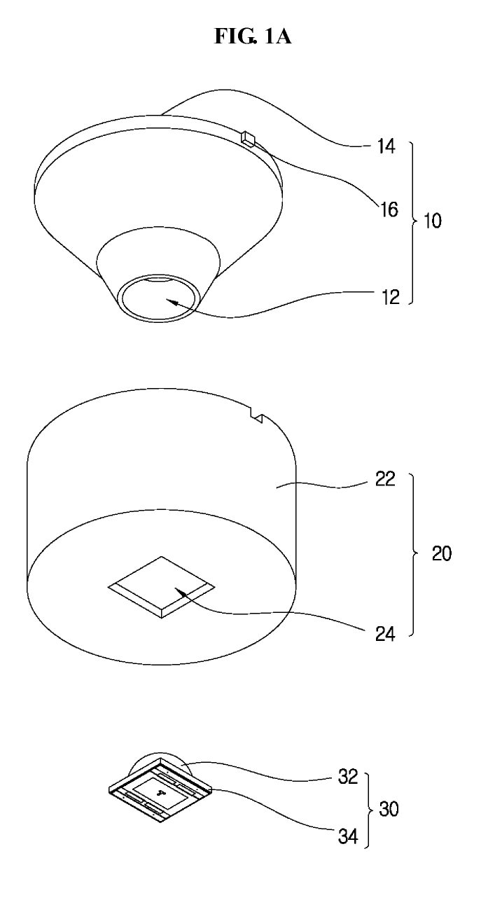

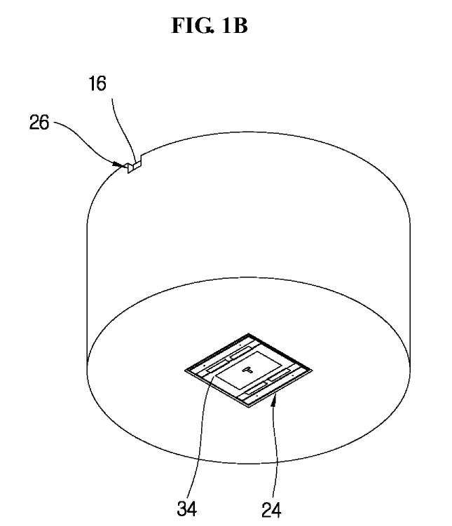

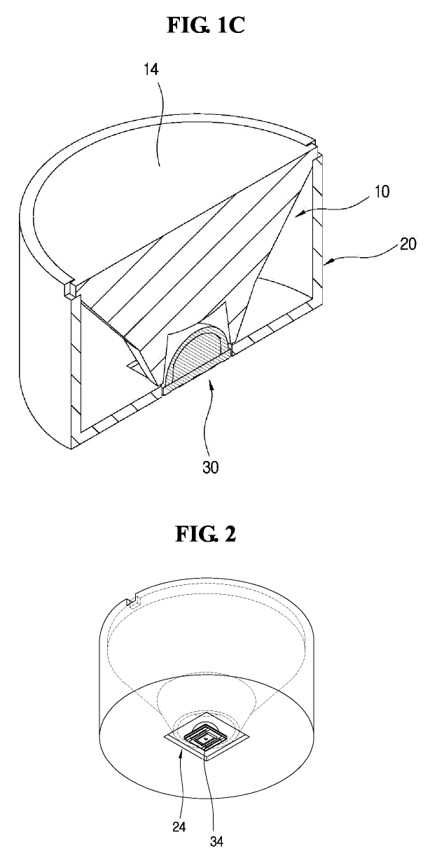

FIG. 1A shows exploded perspective view of a lens according to an exemplary embodiment, FIG. 1B shows assembled view of the lens in FIG. 1A having an LED package coupled thereto, and FIG. 1C shows a cross sectional view of the central region of the lens assembly in FIG. 1B.

Referring to FIG. 1A through FIG. 1C, a lens 10 surrounding the LED package 30 is combined with the LED package 30 after the LED package 30 is formed on a PCB (not shown).

More particularly, the lens 10 comprises the center recess 12 which accommodates an optical member 32 formed on an upper part of the LED package 30, and the circumference of the recess 12 may be shorter than that of an emission part 14 of the lens 10 where the light from the LED package 30 emits.

Further, the lens 10 may comprise a cylindrical holder 20 which surrounds an outer peripheral edge of the lens 10 to be combined with the LED package 30. The holder 20 may be a cylindrical structure 22 having a diameter which is able to surround the emission part 14 of the lens 10, and be combined with the lens 10 when a protruding part 16 formed at one side of the emission part 14 of the lens 10 is put in a groove 26 of the holder 20.

Furthermore, an opening 24 having a shape same as the shape of the chip plate 34 of the LED package 30 may be formed at a lower surface of the holder 20. The lens 10, the holder 20, and the LED package 30 illustrated in FIGS. 1B and 1C may be assembled as one unit when the chip plate 34 of the LED package 30 is put in the opening 24.

However, there is a problem in that the shape of the holder 20 should be changed to correspond to the size and shape of the chip plate 34 of the LED package 30 because the lens 10 must comprise the holder 20 corresponding to the chip plate 34 of the LED package 30.

FIG. 2 shows a perspective view of the assembly to illustrate a problem of the lens in FIG. 1A through FIG. 1C when the size of the chip plate 34 changes.

For example, referring to FIG. 2, misalignment may occur and it is impossible to be assembled accurately when the size of the chip plate 34 is smaller than that of the opening 24, and although not shown in FIG. 2, it is also impossible to be assembled accurately when the size of the chip plate 34 is bigger than that of the opening 24.

To solve this problem, another exemplary embodiment of this invention provides a lens which includes a lens part and a lens housing surrounding an outer peripheral edge of the lens part, and the lens housing is integrally formed within one body with the lens part.

Further, the lens housing comprises at least one alignment protrusion at the lower portion of the lens housing, and the alignment protrusion is inserted to an alignment groove formed on a PCB of an LED lighting apparatus to combine with the LED package and the PCB.

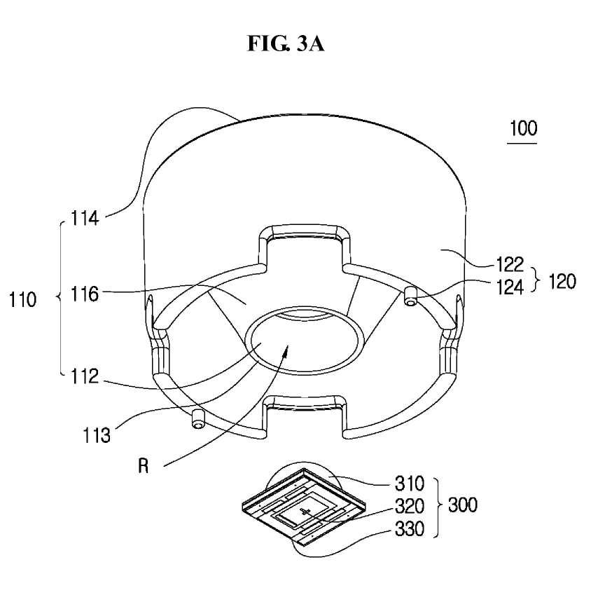

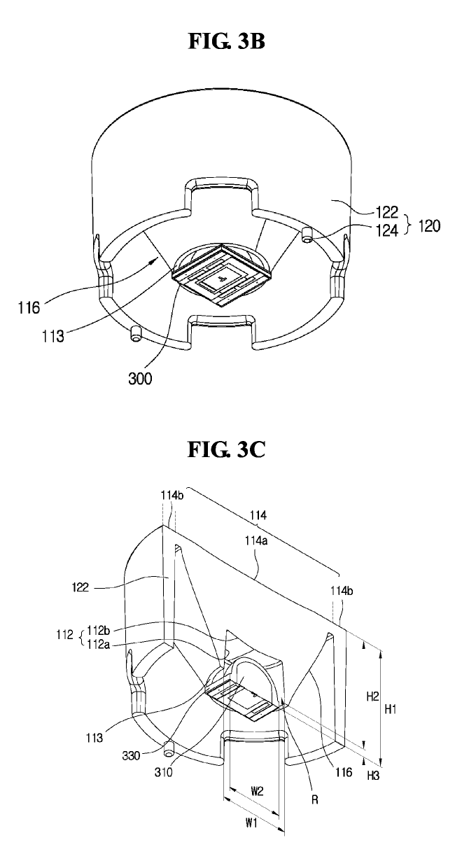

FIG. 3A shows exploded perspective view of a lens according to another exemplary embodiment, FIG. 3B shows an assembled view of the lens in FIG. 3A having an LED package coupled thereto, and FIG. 3C shows a cross sectional view of the central region of the lens in FIG. 3B.

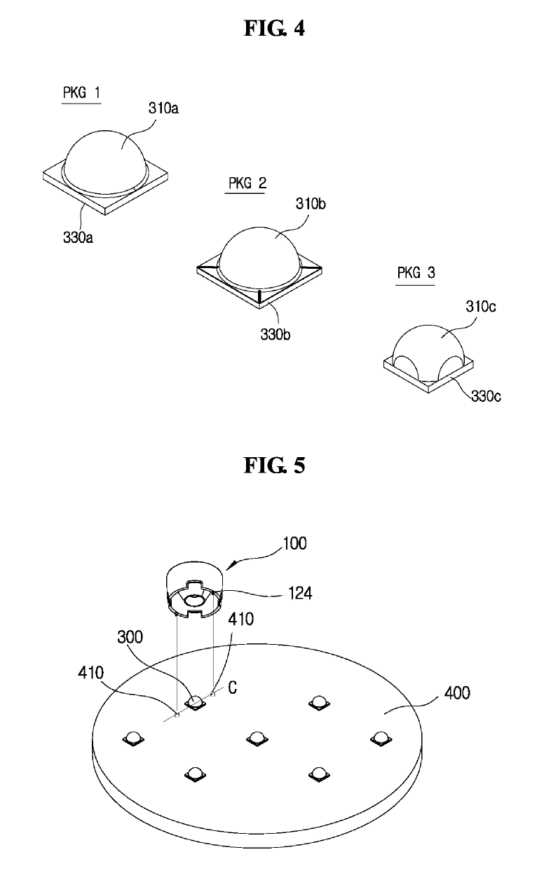

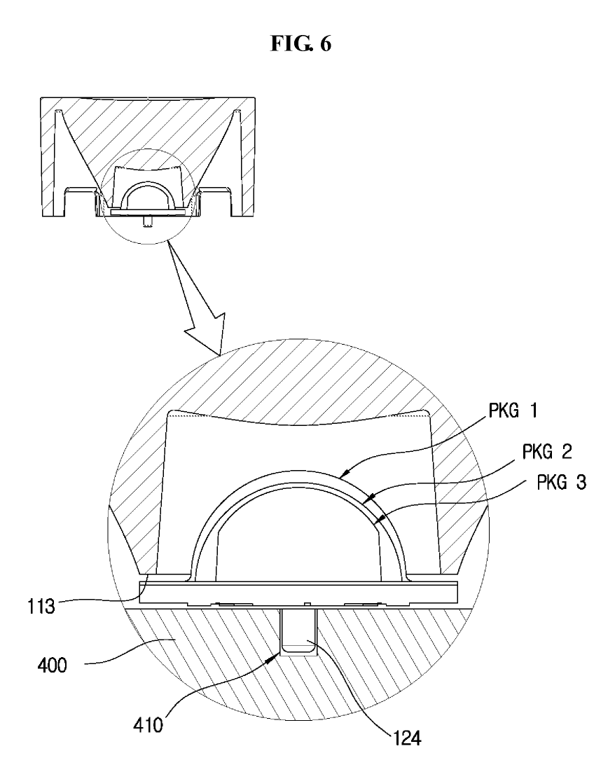

Further, FIG. 4 shows LED packages in various sizes, FIG. 5 shows a PCB having a plurality of LED packages bonded thereon, and FIG. 6 is an enlarged cross section view illustrating a status of combining with the lens assembly and an alignment groove in the PCB in FIG. 5

Referring to FIGS. 3A through 3C, the lens 100 according to another exemplary embodiment includes a lens part 110 including an incidence surface 112, an emission surface 114, and outer surface 116; and a holder part 120 including a lens housing 122 which integrally connected with edge of the emission surface 114 and surrounds an outer peripheral of the lens part 110, and at least one alignment protrusion 124 located at a lower portion of the lens housing 122.

An LED package 300 combined with the lens 100 may include an LED chip 320, a chip plate 330 accommodating the LED chip 320, and an optical member 310 disposed on an upper part of the LED chip 320.

The LED package 300 may be fabricated in various sizes illustrated in FIG. 4. In other words, each size of the optical member 310 and/or the chip plate 330 in the LED package 300 may vary in each package such as PKG1, PKG2, and PKG3 in FIG. 4

For example, the size of the chip plates 330a and 330b of a first and a second LED packages PKG1 and PKG2 is substantially similar. However, the height and the size of the optical member 310a in the first LED package PKG1 are greater than those of the optical member 310b in the second LED package PKG2. Further, the third LED package PKG3 has an optical member 310c and a chip plate 330c smaller in size than those of the first and the second packages PKG1 and PKG2.

Referring to FIG. 5, the LED package 300 may be bonded on a surface of the printed circuit board PCB 400 included in the LED lighting apparatus.

Referring to FIG. 3A through 3C, the incidence surface 112 of the lens 100 may refer to an optical surface through which light emitted from the optical member 310 of the LED package 300 is incident onto the lens 100. The incidence surface 112 may be formed as a recess R which is extends upwards, i.e., toward the emission surface 114, from a lower surface 113. Therefore, the incidence surface 112 includes a refractive surface 112b that continues a bottom of the recess R and an inner surface 112a that extends away from the refractive surface 112b to constitute a side of the recess R.

The optical member 310 of the LED package 300 is inserted to the inside of the lens part 110 through an opening area of the recess R, and, for this, the width of the opening area of the recess R is formed larger than that of the optical member 310 of the LED package 300.

That is, the width W1 of the opening area of the recess R may be formed larger than the width W2 of the optical member 310 of the first LED package PKG1 so as to enable the lens 100 to be combined with any of the LED packages PKG1, PKG2, and PKG3 illustrated in FIG. 4.

The refractive surface 112b may have shape that is convex toward the optical member 310 of the LED package. For example, the refractive surface 112b may be formed in a hemispherical lens structure having a predetermined radius of curvature. The refractive surface 112b may concentrate the light emitted from the LED package onto the emission surface 114.

The inner surface 112a, as illustrated in FIG. 3C, is inclined at a predetermined angle with respect to the lower surface 113 so that a horizontal section of the recess R widens toward the lower surface 113. The light emitted from a side of the LED package may be incident onto and refracted from the inner surface 112a. Since the inner surface 112a is inclined, the incident and refracted light may have a slightly smaller angle with respect to the outer surface 116. Therefore, a total reflection occurs on the outer surface 116 to allow the light to go toward the emission surface 114.

The lower surface 113 may have a surface that encloses the opening area of the recess R. In certain embodiments, the lower surface 113 may not exist. For example, if the recess R is formed so that the outer surface 116 immediately meets the inner surface 112a, the lower surface may not exist.

The emission surface 114 may refer to an optical surface that emits the light incident onto the lens part 110. The emission surface 114 may be formed as a circular plane form in the lens part 110, but it is not limited thereto. For example, the emission surface 114 may have a substantially elliptical plane shape, or a polygonal plane shape, such as, a pentagonal plane shape, or a hexagonal plane shape. Further, the emission surface 114 may have a curved surface such as spherical surface or an aspherical surface.

Referring to FIG. 3C, the emission surface 114 may comprise a first surface 114a corresponding to lighting side, and a second surface 114b that extends from the outer edge of the first surface 114a and is connected integrally to the lens housing 122 of the holder part. The second surface 114b may be an upper surface of the lens housing 122 and consist of a part of the emission surface 114 being placed in one plane with the first surface 114a.

The outer surface 116 constitutes an outer part of the lens part 110 along with the incidence surface 112 and the emission surface 114, and connects the incidence surface 112 and the emission surface 114 to each other. The outer surface 116 totally reflects light incident onto the lens part 110 toward the emission surface 114.

Looking over the holder part 120, the lens housing 122 extends downwardly from the outer edge which may be the second surface 114b of the emission surface 114 of the lens part 110 and surrounds the outer surface 116 of the lens part 110.

The lens housing 122 is formed integrally with the emission surface 114 and the emission surface 114 is connected to the outer surface 116 of the lens part 110, and eventually, the lens housing 122 may be formed integrally with the lens part 110 as one-body. For example, the lens 100 according to the exemplary embodiment of the present invention may be formed as one-body by molding the second lens part 110 and the holder 120 at the same time.

The shape of the lens housing 122 corresponds to that of the emission surface of the lens part 110. For example, if the shape of the emission surface 114 is a circular plane form, which of the lens housing may be formed as a cylinder, however it is not limited thereto. Therefore, the lens housing may be formed as various polygonal shapes following the shape of the exit surface such as a quadrangle, pentagon, hexagon, etc.

The lens housing 122 fixes the LED package 300 to enable the optical member 310 of the LED package to be inserted in the recess R of the lens part 110.

Referring to FIG. 5, the lens housing 122 is combined with the PCB so that the lens 100 can be coupled to the LED package 300 since the LED package 300 is bonded to the PCB 400.

Referring to FIG. 3A to 3C, the height H1 of the lens housing 122 should be greater than that of the outer surface 116 of the lens part 110 since it is only the optical member of the LED package which is inserted in the recess R of the lens part 110. The chip plate 330 may not be inserted into the recess R, and the upper side of the chip plate 330 may contact the lower surface 113 enclosing the recess R.

For example, the height H1 of the lens housing 122 may be greater than the height H2 of the outer surface 116 by the height H3 of the chip plate 330.

Each of the lens housing 122 and the PCB 400 may have structures for combining the elements together.

Therefore, the lens housing 122 may have at least one alignment protrusion 124, and the lens housing 122 may be combined with the PCB 400 by inserting or wedging the alignment protrusion 124 in an alignment groove 410 formed on the PCB 400.

Furthermore, the alignment protrusion 124 is beneficial in correctly aligning the lens part 110 with the optical member 310 of the LED package.

Referring to FIG. 5, the alignment groove 410 formed on the PCB 400 may be formed on the line C across the center of the LED package 300.

Therefore, when the alignment protrusion 124 is inserted or wedged in the alignment groove 410, the lens part 110 is aligned with the optical member 310 of the LED package while being combined.

Referring to FIG. 6, the lens part 110 according to an exemplary embodiment is aligned correctly with the optical member of the LED packages such as PKG1, PKG2, and PKG3 by inserting or wedging the alignment protrusion 124 in the alignment groove 410 of the PCB 400.

Therefore, even if any of the LED packages such as PKG1, PKG2, and PKG3 is boned to the PCB 400, the lens part 110 is aligned correctly with any of the packages by forming the alignment groove 410 on the PCB 400 and inserting or wedging the alignment protrusion 124 in the alignment groove 410.

Consequently, additional element such as a holder is not necessary, and, regardless of the size and the type of the LED package 300, it is possible to combine the lens with the LED package being aligned correctly, and this can maximize cost saving.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A lens, comprising:
a lens part comprising an incidence surface onto which light is incident and a emission surface through which the light incident onto the incidence surface is emitted, and an outer surface which reflects the light incident onto the incidence surface toward the emission surface; and
a holder part comprising a lens housing integrally connected with an edge of the emission surface and surrounding an outer peripheral of the lens part, and at least one alignment protrusion located at a lower portion of the lens housing.

2. The lens of claim 1, wherein the incidence surface is formed along a recess that extends toward the emission surface.

3. The lens of claim 2, wherein the incidence surface comprises a refractive surface comprising a bottom of the recess and an inner surface extending away from the refractive surface to form a side of the recess.

4. The lens of claim 3, wherein an optical member of a light emitting diode (LED) package is inserted into the inside of the lens part through an opening area of the recess.

5. The lens of claim 3, wherein a width of an opening area of the recess is greater than a width of an optical member of a light emitting diode (LED) package.

6. The lens of claim 2, wherein the lens part further comprises a lower surface, and wherein the lower surface encloses an opening area of the recess and is configured to contact an upper side of a chip plate of a light emitting diode (LED) package.

7. The lens of claim 1, wherein the emission surface comprises a first surface corresponding to lighting side, and a second surface extending from the outer edge of the first surface and connecting integrally to the lens housing of the holder part.

8. The lens of claim 1, wherein a height of the lens housing is greater than a height of the outer surface of the lens part.

9. A light emitting diode (LED) lighting apparatus, comprising:
a printed circuit board (PCB) on which a plurality of LED packages is arranged;
a plurality of alignment grooves formed on the PCB corresponding to the plurality of LED packages; and
a plurality of lenses inserted into the plurality of alignment grooves corresponding to a plurality of the LED packages;
wherein each of the lenses comprises;
a lens part comprising an incidence surface onto which light is incident, a emission surface through which the light incident onto the incidence surface is emitted, and an outer surface which reflects the light incident onto the incidence surface toward the emission surface; and
a holder part comprising a lens housing integrally connected with an edge of the emission surface and surrounding an outer peripheral of the lens part, and a plurality of alignment protrusions located at a lower portion of the lens housing and configured to be inserted into the plurality of alignment grooves.

10. The LED lighting apparatus of claim 9, wherein each of the alignment grooves is located on a line across a center of each of the LED packages.

11. The LED lighting apparatus of claim 9, wherein each of the incidence surfaces is formed along a recess that extends toward the emission surface.

12. The LED lighting apparatus of claim 11, wherein each of the incidence surfaces comprises a refractive surface forming a bottom of the recess and an inner surface extending away from the refractive surface to form a side of the recess.

13. The LED lighting apparatus of claim 12, wherein an optical member of each of the LED packages is inserted into the inside of each lens part through an opening area of the recess.

14. The LED lighting apparatus of claim 12, wherein a width of an opening area of each recess is greater than that of each optical member of the LED packages.

15. The LED lighting apparatus of claim 9, wherein each emission surface comprises a first surface corresponding to lighting side, and a second surface extending from an outer edge of the first surface and connecting integrally to the lens housing of the holder part.

16. The LED lighting apparatus of claim 9, wherein a height of each lens housing is greater than a height of the outer surface of each lens part.

17. A lens, comprising:
a lens part comprising an incidence surface onto which light is incident, an emission surface through which the light incident onto the incidence surface is emitted, and an outer surface which reflects the light incident onto the incidence surface toward the emission surface; and
a lens housing integrally connected with an edge of the emission surface and surrounding an outer peripheral of the lens part,
wherein the incidence surface is formed along a recess that extends toward the emission surface, and
wherein only an optical member of a light emitting diode (LED) package is inserted into the inside of the lens part through an opening area of the recess.

18. The lens of claim 17, further comprising:
at least one alignment protrusion formed at a lower portion of the lens housing.

19. The lens of claim 17, wherein a width of the opening area of the recess is greater than a width of the optical member of the LED package.

20. The lens of claim 17, wherein the lens part further comprises a lower surface, and wherein the lower surface encloses the opening area of the recess and is configured to contact an upper side of a chip plate of the LED package.

21. The lens of claim 17, wherein the emission surface comprises a first surface corresponding to lighting side, and a second surface extending from the outer edge of the first surface and connecting integrally to the lens housing.

22. The lens of claim 17, wherein a height of the lens housing is greater than a height of the outer surface of the lens part.
